(19) United States
(12) Patent Application Publication
(10) Pub. No.: US 2024/0136586 A1
(43) Pub. Date: Apr. 25, 2024

(54) FLAME RETARDANT OR NONFLAMMABLE ELECTROLYTIC SOLUTION, AND LITHIUM SECONDARY BATTERY COMPRISING SAME

(71) Applicant: THE INDUSTRY & ACADEMIC COOPERATION IN CHUNGNAM NATIONAL UNIVERSITY (IAC), Daejeon (KR)

(72) Inventors: Seung-Wan SONG, Sejong (KR); Kihun AN, Daejeon (KR)

(21) Appl. No.: 18/275,459

(22) PCT Filed: Feb. 8, 2022
(86) PCT No.: PCT/KR2022/001915

§ 371 Date: Aug. 2, 2023

(30) Foreign Application Priority Data
Feb. 8, 2021 (KR) 10-2021-0017626
Feb. 8, 2022 (KR) 10-2022-0015886

(51) Int. Cl. H01M 10/0569; H01M 10/0525; H01M 10/0568

(52) U.S. Cl. CPC H01M 10/0569; H01M 10/0525; H01M 10/0568; H01M 2300/0034; H01M 2300/0037

(57) ABSTRACT

The present disclosure relates to a flame retardant or non-flammable liquid electrolyte and a lithium secondary battery including the same, wherein the liquid electrolyte is flame retardant or non-flammable and capable of preventing accidents such as a lithium secondary battery being on fire, catching fire, or exploding from occurring, thereby significantly improving battery safety, is capable of obtaining increased battery energy density by allowing high-voltage charge, is capable of rapid charge, and is capable of maintaining excellent battery performance for a long period of time.

### TECHNICAL FIELD

The present disclosure relates to a flame retardant or non-flammable liquid electrolyte and a lithium secondary battery including the same.

### BACKGROUND ART

A lithium secondary battery is formed with a positive electrode, a negative electrode, a separator and an liquid electrolyte. As the liquid electrolyte, a non-aqueous organic liquid electrolyte having lithium ion conductivity is used, which causes a problem of being vulnerable to fire and explosion due to its flammable nature. This poses a great threat to safety of users and surrounding environments in the event of accidents such as fire and explosion of a lithium secondary battery.

Particularly, a medium to large lithium secondary battery used in electric vehicles (EV), energy storage systems (ESS) and the like has an amplified risk of fire and explosion, and various studies to overcome such a risk are in progress.

As one example, a method of using an additive having flame retardancy such as phosphazene, phosphate, phosphite, an ionic liquid or an aqueous liquid electrolyte has been proposed, however, there are problems of a cost increase caused by a high price and battery performance degradation.

Studies on a solid electrolyte-based all-solid-state battery are also in progress, however, there is a problem of large interfacial resistance between a solid electrolyte and an electrode, leading to problems of making long-term charge-discharge performance impossible and making an improvement in energy density difficult, and in addition thereto, there is a problem in that processes of manufacturing an electrode, an electrolyte and an all-solid-state battery are expensive compared to existing battery processes.

In other words, although safety is improved in all of these, there are problems of degrading battery performance and increasing battery price, and accordingly, development of an liquid electrolyte capable of preventing battery performance from being degraded while improving safety of a lithium secondary battery is still required.

### Prior Art Documents

[Patent Documents]
(Patent Document 1) KR 10-2016-0011548 A1

### DISCLOSURE

### Technical Problem

The present disclosure is directed to providing, as an liquid electrolyte for a lithium secondary battery, a flame retardant or non-flammable liquid electrolyte having excellent stability with no or little risk of fire and explosion.

The present disclosure is also directed to providing a lithium secondary battery including the flame retardant or non-flammable liquid electrolyte, the battery capable of providing excellent stability, rapid charge, high performance and high energy density.

### Technical Solution

In view of the above, one embodiment of the present disclosure provides a flame retardant or non-flammable liquid electrolyte including a lithium salt; a first solvent including a compound represented by the following Chemical Formula 1; and a second solvent including a compound represented by the following Chemical Formula 2:

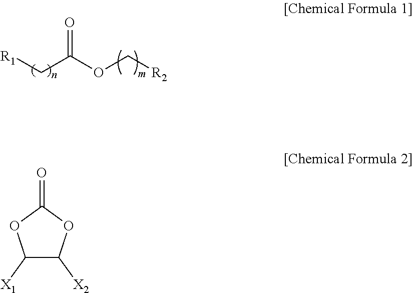

herein,
n and m are the same as or different from each other, and each independently an integer of 0 to 5,
R₁ and R₂ are the same as or different from each other, and each independently hydrogen or a substituted or unsubstituted alkyl group having 1 to 10 carbon atoms, and
X₁ and X₂ are the same as or different from each other, and may be each independently selected from the group consisting of hydrogen, a halogen group and a substituted or unsubstituted alkyl group having 1 to 10 carbon atoms.

The lithium salt may be selected from the group consisting of LiPF₆, LiClO₄, LiAsF₆, LiBF₄, LiSbF₆, LiAlO₄, LiAlCl₄, LiCF₃SO₃, LiC₄F₉SO₃, LiC₆H₅SO₃, LiN(C₂F₅SO₃)₂, LiN(C₂F₅SO₂)₂, LiN(CF₃SO₂)₂. LiN(FSO₂)₂, LiN(CₓF₂ₓ₊₁SO₂)(C_{y}F_{2y+1}SO₂) (herein, x and y are 0 or natural number), LiCl, LiI, LiSCN, LiB(C₂O₄)₂, LiF₂BC₂O₄, LiPF₄(C₂O₄), LiPF₂(C₂O₄)₂, LiPO₂F₂, LiP(C₂O₄)₃ and mixtures thereof.

The first solvent and the second solvent may have a volume ratio of 99:1 to 1:99, and the first solvent and the second solvent may have a volume ratio of 90:10 to 10:90.

The flame retardant or non-flammable liquid electrolyte may have a self-extinguishing time (SET) of less than 20 seconds/g.

A lithium secondary battery according to another embodiment of the present disclosure may include a positive electrode including a positive electrode active material; the flame retardant or non-flammable liquid electrolyte; a negative electrode; and a separator.

The lithium secondary battery may be a lithium ion secondary battery, a lithium metal secondary battery or an all-solid-state lithium secondary battery.

In the present disclosure, “hydrogen” is hydrogen, light hydrogen, deuterium or tritium.

In the present disclosure, a “halogen group” is fluorine, chlorine, bromine or iodine.

In the present disclosure, an “alkyl” means a monovalent substituent derived from a linear or branched saturated hydrocarbon having 1 to 40 carbon atoms. Examples thereof may include methyl, ethyl, propyl, isobutyl, sec-butyl, pentyl, iso-amyl, hexyl and the like, but are not limited thereto.

In the present specification, “substituted” means that a hydrogen atom bonding to a carbon atom of a compound is changed to another substituent, and the position of substitution is not limited as long as it is a position at which the hydrogen atom is substituted, that is, a position at which the substituent is capable of substituting, and when two or more substituents substitute, the two or more substituents may be the same as or different from each other. The substituent may be substituted with one or more substituents selected from the group consisting of hydrogen, a cyano group, a nitro group, a halogen group, a hydroxyl group, a carboxyl group, an alkoxy group having 1 to 10 carbon atoms, an alkyl group having 1 to 30 carbon atoms, an alkenyl group having 2 to 30 carbon atoms, an alkynyl group having 2 to 24 carbon atoms, a heteroalkyl group having 2 to 30 carbon atoms, an aralkyl group having 6 to 30 carbon atoms, an aryl group having 5 to 30 carbon atoms, a heteroaryl group having 2 to 30 carbon atoms, a heteroarylalkyl group having 3 to 30 carbon atoms, an alkoxy group having 1 to 30 carbon atoms, an alkylamino group having 1 to 30 carbon atoms, an arylamino group having 6 to 30 carbon atoms, an aralkylamino group having 6 to 30 carbon atoms and a heteroarylamino group having 2 to 24 carbon atoms, and when substituted with a plurality of substituents, these are the same as or different from each other, and the substituent is not limited to the above-described examples.

### Advantageous Effects

The present disclosure relates to, as an liquid electrolyte for a lithium secondary battery, a flame retardant or non-flammable liquid electrolyte having excellent stability with no or little risk of fire and explosion, and a lithium secondary battery including the flame retardant or non-flammable liquid electrolyte is capable of providing excellent stability, rapid charge, high performance and high energy density.

### BRIEF DESCRIPTION OF DRAWINGS

FIG. 1 is a Nyquist plot of internal interfacial resistance of a lithium ion battery measured using electrochemical impedance spectroscopy (EIS).

FIG. 2 is a Nyquist plot obtained by measuring internal interfacial resistance of a lithium ion battery using EIS after performing 500 charge-discharge cycles.

### BEST MODE

The present disclosure relates to a flame retardant or non-flammable liquid electrolyte including a lithium salt; a first solvent including a compound represented by the following Chemical Formula 1; and a second solvent including a compound represented by the following Chemical Formula 2:

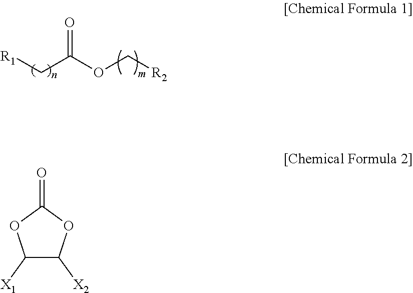

herein,
n and m are the same as or different from each other, and each independently an integer of 0 to 5,
R₁ and R₂ are the same as or different from each other, and each independently hydrogen or a substituted or unsubstituted alkyl group having 1 to 10 carbon atoms, and
X₁ and X₂ are the same as or different from each other, and may be each independently selected from the group consisting of hydrogen, a halogen group and a substituted or unsubstituted alkyl group having 1 to 10 carbon atoms.

### MODE FOR INVENTION

Hereinafter, a lithium secondary battery according to the present disclosure, and a method for manufacturing the same will be described in detail. Drawings introduced below are provided as an example so that the spirit of the present disclosure is sufficiently conveyed to those skilled in the art. Accordingly, the present disclosure may be embodied in other forms without being limited to the drawings provided below, and the drawings provided below may be exaggerated to clarify the spirit of the present disclosure. Technical terms and scientific terms used herein have meanings commonly understood by those of ordinary skill in the art unless there are other definitions, and descriptions on known functions and constitutions that may unnecessarily obscure the gist of the present disclosure will not be provided in the following descriptions and accompanying drawings.

Commercially available liquid electrolytes of a lithium secondary battery are vulnerable to fire and explosion by having flammable properties, posing a great threat to safety of users and surrounding environments.

In order to overcome such a problem, a method of using an additive having flame retardancy such as phosphazene, phosphate, phosphite or an ionic liquid, and an all-solid-state battery based on solid electrolytes such as polymers, sulfides and oxides have been proposed. However, these all have problems of degrading battery performance and increasing battery price despite improved safety.

Accordingly, the present disclosure is to develop a lithium secondary battery capable of preventing battery performance degradation while improving safety of the lithium secondary battery, and is capable of providing a flame retardant or non-flammable liquid electrolyte having excellent stability with no or little risk of fire and explosion when using a mixture of two different series of solvents and using high nickel NCM (nickel-cobalt-manganese) as a positive electrode active material, and the lithium secondary battery including the flame retardant or non-flammable liquid electrolyte is capable of providing excellent stability, rapid charge, high performance and high energy density.

Specifically, the flame retardant or non-flammable liquid electrolyte of the present disclosure may include a lithium salt; a first solvent including a compound represented by the following Chemical Formula 1; and a second solvent including a compound represented by the following Chemical Formula 2:

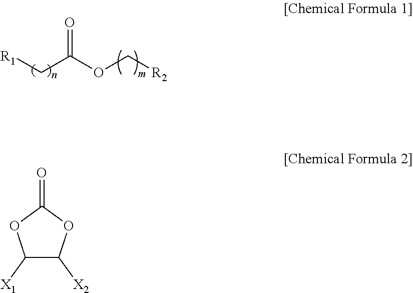

herein,
n and m are the same as or different from each other, and each independently an integer of 0 to 5,
R₁ and R₂ are the same as or different from each other, and each independently hydrogen or a substituted or unsubstituted alkyl group having 1 to 10 carbon atoms, and
X₁ and X₂ are the same as or different from each other, and may be each independently selected from the group consisting of hydrogen, a halogen group and a substituted or unsubstituted alkyl group having 1 to 10 carbon atoms.

By using a mixed solvent of the first solvent including the compound represented by Chemical Formula 1 and the second solvent including the compound represented by Chemical Formula 2 in the liquid electrolyte, the non-aqueous liquid electrolyte may have a non-ignition property of flame retardancy or non-flammability, and through this, accidents such as a lithium secondary battery catching fire or exploding may be prevented from occurring in the event of a disaster such as fire, which may greatly improve safety.

Specifically, the ignition property of an liquid electrolyte may be defined such that, depending on a self-extinguishing time (SET (unit: second/g)), SET<6 is defined as non-flammable, 6<SET<20 as flame retardant and SET≥20 as flammable, and the flame retardant or non-flammable liquid electrolyte according to one embodiment of the present disclosure may have a self-extinguishing time of less than 20 seconds/g, more preferably less than 6 second/g, and even more preferably less than 3 seconds/g. Herein, the self-extinguishing time may have a lower limit of 0 second/g. Through a self-extinguishing time property as above, the liquid electrolyte of the present disclosure may exhibit an ignition property of flame retardancy or non-flammability.

In addition, unlike existing methods in which battery performance is degraded when safety is improved, battery performance degradation may be prevented while securing a non-ignition property through a combination of the liquid electrolyte including a mixed solvent of the first solvent and the second solvent, and, as to be described below, a high nickel NCM positive electrode active material represented by Chemical Formula 3.

In one embodiment of the present disclosure, the flame retardant or non-flammable liquid electrolyte is for improving safety of a lithium secondary battery, and by using a mixed solvent of the first solvent including the compound represented by Chemical Formula 1 and the second solvent including the compound represented by Chemical Formula 2 in the liquid electrolyte, the non-aqueous liquid electrolyte may have a non-ignition property of flame retardancy or non-flammability, and through this, accidents such as a lithium secondary battery catching fire or exploding may be prevented from occurring in the event of a disaster such as fire, which may greatly improve safety.

More specifically, the first solvent may include a linear ester-based compound represented by the following Chemical Formula 1:

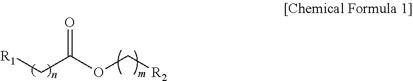

herein,
n and m are the same as or different from each other, and each independently an integer of 0 to 5, and
R₁ and R₂ are the same as or different from each other, and may be each independently hydrogen or a substituted or unsubstituted alkyl group having 1 to 10 carbon atoms.

As a specific example, the compound represented by Chemical Formula 1 may be selected from the group consisting of fluoromethyl acetate, difluoromethyl acetate, trifluoromethyl acetate, 2-fluoroethyl acetate, 2,2-difluoroethyl acetate, 2,2,2-trifluoroethyl acetate, fluoromethyl propionate, difluoromethyl propionate, trifluoromethyl propionate, 2-fluoroethyl propionate, 2,2-difluoroethyl propionate, 2,2,2-trifluoroethyl propionate, 2-fluoroethyl butyrate, 2,2-difluoroethyl butyrate, 2,2,2-trifluoroethyl butyrate (TFEB) and mixtures thereof, and may be preferably 2,2,2-trifluoroethyl acetate (TFEA) or 2,2,2-trifluoroethyl propionate (TFEP). However, the compound represented by Chemical Formula 1 is not limited to the above-mentioned examples of the compound, and linear ester-based compounds exhibiting flame retardancy or non-flammability and capable of maintaining excellent battery performance may all be used without limit.

The second solvent according to one embodiment of the present disclosure may include a cyclic carbonate-based compound represented by the following Chemical Formula 2:

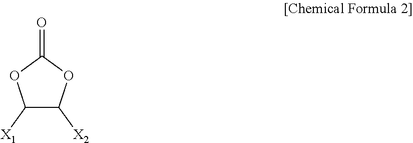

herein,
X₁ and X₂ are the same as or different from each other, and may be each independently selected from the group consisting of hydrogen, a halogen group and a substituted or unsubstituted alkyl group having 1 to 10 carbon atoms.

As a specific example, the compound represented by Chemical Formula 2 may be selected from the group consisting of ethylene carbonate (EC), propylene carbonate (PC), fluoroethylene carbonate (FEC), 4,4-difluoroethylenecarbonate, 4,5-difluoroethylenecarbonate, 4-methyl-5-fluoroethylene carbonate, 4-methyl-5,5-difluoroethylene carbonate, 4-(fluoromethyl)ethylene carbonate, 4-(difluoromethyl)ethylene carbonate, 4-(trifluoromethyl)ethylene carbonate, 4-(2-fluoroethyl)ethylene carbonate, 4-(2,2-difluoroethyl)ethylene carbonate, 4-(2,2,2-trifluoroethyl)ethylene carbonate, 4,5-dimethylethylene carbonate and mixtures thereof, and is preferably propylene carbonate (PC). However, cyclic carbonate-based compounds exhibiting flame retardancy or non-flammability and capable of maintaining excellent battery performance may all be used without limit.

In addition, by properly adjusting the % by volume of each solvent, performance degradation of a lithium secondary battery may be more effectively prevented while securing an excellent non-ignition property of flame retardancy or non-flammability.

As a specific example, the first solvent and the second solvent have a volume ratio of 99:1 to 1:99, 90:10 to 10:90, 90:10 to 55:45, 90:10 to 60:40, and 80:20 to 60:40. By mixing the solvents in such a volume ratio, a lithium secondary battery having, while securing a non-ignition property of less than 20 seconds/g, discharge capacity of 180 mAh/g or greater after 100 charge-discharge cycles, a capacity retention rate of 75% or greater after 100 charge-discharge cycles and initial Coulombic efficiency of 80% or greater may be provided when using high nickel NCM as a positive electrode active material. Herein, an upper limit of the discharge capacity is not particularly limited, but may be, for example, 250 mAh/g.

Furthermore, the flame retardant or non-flammable liquid electrolyte includes a lithium salt, and the lithium salt may be selected from the group consisting of LiPF₆, LiClO₄, LiAsF₆, LiBF₄, LiSbF₆, LiAlO₄, LiAlCl₄, LiCF₃SO₃, LiC₄F₉SO₃, LiC₆H₅SO₃, LiN(C₂F₅SO₃)₂, LiN(C₂F₅SO₂)₂, LiN(CF₃SO₂)₂. LiN(FSO₂)₂, LiN(CₓF₂ₓ₊₁SO₂)(C_{y}F_{2y+1}SO₂) (herein, x and y are 0 or natural number), LiCl, LiI, LiSCN, LiB(C₂O₄)₂, LiF₂BC₂O₄, LiPF₄(C₂O₄), LiPF₂(C₂O₄)₂, LiPO₂F₂, LiP(C₂O₄)₃ and mixtures thereof. However, those commonly used in the art may be used without particular limit.

The lithium salt in the flame retardant or non-flammable liquid electrolyte may have a concentration of 0.1 M to 60 M, more preferably 0.5 M to 10 M, and even more preferably 0.9 M to 1.5 M. However, the concentration is not limited to the above-mentioned range, and lithium salt concentration ranges exhibiting flame retardancy or non-flammability and capable of exhibiting excellent stability may all be used.

The flame retardant or non-flammable liquid electrolyte may further include an additive, and as the additive, those commonly used in the art may be used without particular limit.

Specifically, the additive may be selected from the group consisting of, for example, vinylene carbonate (VC), vinylene ethylene carbonate (VEC), propane sultone (PS), fluoroethylene carbonate (FEC), ethylene sulfate (ES), lithium fluorophosphate (LiPO₂F₂), lithium oxalyldifluoroborate (LiODFB), lithium bis(oxalato)borate (LiBOB) and mixtures thereof, but is not limited to the examples.

The added amount of the additive in the liquid electrolyte may also be adjusted to a level commonly used in the art, and specifically, the added amount of the additive may be, for example, from 0.1% by weight to 10% by weight, more preferably from 0.2% by weight to 5% by weight and most preferably from 0.1% by weight to 2% by weight in the total weight of the liquid electrolyte.

The lithium secondary battery according to another embodiment of the present disclosure may include a positive electrode including a positive electrode active material; the flame retardant or non-flammable liquid electrolyte; a negative electrode; and a separator.

As the positive electrode active material, a compound represented by the following Chemical Formula 3, LiMn_{2-c}McO₄, LiFePO₄, LiMnPO₄, LiCoPO₄, LiFe_{1-c}McPO₄, Li_{1.2}Mn_{(0.8-d)}M_{d}O₂, Li₂N_{1-c}M_{c}O₃ (N and M are metal or transition metal), Li₁₊ₑN_{y-c}M_{c}O₂(N is Ti or Nb, M is V, Ti, Mo or W), Li₄Mn_{2-c}M_{c}O₅(M is metal or transition metal), Li_{c}M_{2-c}O₂, Li₂O/Li₂Ru_{1-c}M_{c}O₃ and the like may be used, however, these are just an example, and known positive electrode active materials may be used without limit:

LiₐNiₓCo_{y}Mn_{z}O₂ [Chemical Formula 3]
herein,
0.8≤a≤1.2,
0.3<x≤1,
0≤y<0.5,
0≤z<0.6, and
x+y+z=1.

M and N of the compound expressed as the positive electrode active material mean a metal or transition metal. The metal or transition metal may be Al, Mg, B, Co, Fe, Cr, Ni, Ti, Nb, V, Mo or W, however, all may be used without being limited to the above-mentioned range. In addition, c may be 0, 0.2, 0.5 and the like, but is not limited to the above-mentioned examples, and compounds usable as a positive electrode active material may all be used.

The compound represented by Chemical Formula 3 may be a compound represented by the following Chemical Formula 4:

LiₐNiₓCo_{y}Mn_{z}O₂ [Chemical Formula 4]
herein,
0.9≤a≤1.1,
0.6≤x≤0.95,
0≤y≤0.3,
0.01≤z≤0.3, and
x+y+z=1.

In addition, in Chemical Formula 4, a, x, y and z may be preferably 0.95≤a≤1.05, 0.7≤x≤0.9, 0≤y≤0.15, 0.05≤z≤0.15, and x+y+z=1.

As described above, by using the high nickel NCM-based material represented by Chemical Formula 3 as the positive electrode active material, battery performance degradation may be prevented despite the use of the flame retardant or non-flammable liquid electrolyte.

Specifically, by using the high nickel NCM-based material represented by Chemical Formula 3 as the positive electrode active material, rapid charge, high performance and high energy density may be accommodated while having excellent safety with no or little risk of fire and explosion.

As a more specific example, the lithium secondary battery including the positive electrode active material represented by Chemical Formula 3, the first solvent and the second solvent may have discharge capacity of 180 mAh/g or greater after 100 charge-discharge cycles, a capacity retention rate of 75% or greater after 100 charge-discharge cycles and initial Coulombic efficiency of 80% or greater, and may more preferably have discharge capacity of 185 mAh/g or greater after 100 charge-discharge cycles, a capacity retention rate of 80% or greater after 100 charge-discharge cycles and initial Coulombic efficiency of 85% or greater. Herein, an upper limit of the discharge capacity is not particularly limited, but may be, for example, 230 mAh/g.

As the negative electrode, those commonly used in the art may be used without particular limit. As a specific example, lithium metal, a lithium alloy, or a negative electrode active material capable of intercalating/deintercalating lithium ions may be used as the negative electrode. The negative electrode active material may be selected from the group consisting of cokes, artificial graphite, natural graphite, soft carbon, hard carbon, an organic polymer compound combustor, carbon fiber, carbon nanotube, graphene, silicon, silicon oxide, tin, tin oxide, germanium, a graphite composite including silicon, silicon oxide, tin, tin oxide or germanium, Li₄Ti₅O₁₂, TiO₂, phosphorus and mixtures thereof, but is not limited to the above-mentioned range, and negative electrode active materials known in the art may all be used without limit.

As the separator, polyethylene, polypropylene, polyvinylidene fluoride or a multilayer film of two or more layers thereof may be used, and a mixed multilayer film such as a polyethylene/polypropylene two-layer separator, a polyethylene/polypropylene/polyethylene three-layer separator or a polypropylene/polyethylene/polypropylene three-layer separator, a separator in which a single surface or both surfaces of these separators are ceramic coated, and the like may be used. However, these are just one example, and separators known in the art may all be used without limit.

Meanwhile, the lithium secondary battery may be a lithium ion secondary battery, a lithium metal secondary battery, an all-solid-state lithium secondary battery or the like, and may be used in portable electronic devices such as smartphones, wearable electronic devices, power tools, drones, electric vehicles (EV), energy storage systems (ESS), electric two-wheeled vehicles including electric bicycles, electric scooters and the like, electric golf carts, electric wheelchairs, electric fly, electric planes, electric boats, electric submarines and the like.

In addition, the lithium secondary battery of the present disclosure may be manufactured in various shapes and sizes such as, in addition to a coin-type, a prism-type, a cylinder-type or a pouch-type.

In addition, as another embodiment of the present disclosure, a method for manufacturing a lithium secondary battery may include a) preparing a positive electrode including a positive electrode active material represented by the following Chemical Formula 3, a polymer binder and a conductor on a current collector; b) preparing an electrode assembly in which the positive electrode, a separator and a negative electrode are sequentially interposed; and c) inserting the electrode assembly into a battery case, and injecting a flame retardant or non-flammable liquid electrolyte including a lithium salt, a first solvent including a compound represented by the following Chemical Formula 1 and a second solvent including a compound represented by the following Chemical Formula 2 to manufacture a lithium secondary battery:

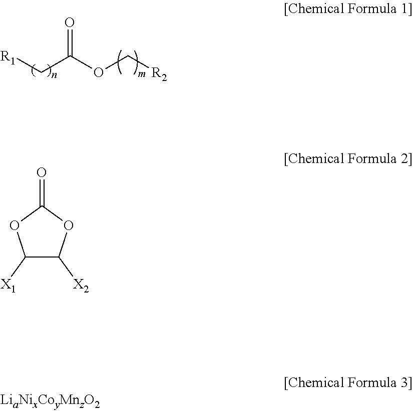

herein,
n and m are the same as or different from each other, and each independently an integer of 0 to 5,
R₁ and R₂ are the same as or different from each other, and each independently hydrogen or a substituted or unsubstituted alkyl group having 1 to 10 carbon atoms,
X₁ and X₂ are the same as or different from each other, and each independently selected from the group consisting of hydrogen, a halogen group and a substituted or unsubstituted alkyl group having 1 to 10 carbon atoms,
0.8≤a≤1.2,
0.3<x≤1,
0≤y<0.5,
0≤z<0.6, and
x+y+z=1.

First, a step of a) preparing a positive electrode by coating a positive electrode slurry, in which the positive electrode active material represented by Chemical Formula 3, a polymer binder and a conductor are mixed, on a current collector may be performed.

Herein, the type of the positive electrode active material is the same as described above, therefore, repeated description will not be provided, and although the added amount of the positive electrode active material is not particularly limited in the content range, the positive electrode active material may be specifically included in an amount of 40% by weight to 99% by weight, more preferably 50% by weight to 98% by weight, and even more preferably 65% by weight to 96% by weight with respect to the total weight of the positive electrode slurry. However, this is just a non-limiting example, and the content is not limited to the above-mentioned numerical range.

The polymer binder according to another embodiment of the present disclosure performs a role of improving adhesive strength between the positive electrode active material particles or between the positive electrode active material and the current collector. Specific examples thereof may include polyvinylidene fluoride (PVDF), polyimide (PI), fluoropolyimide (FPI), polyacrylic acid (PAA), polyvinyl alcohol (PVA), carboxymethyl cellulose (CMC), starch, hydroxypropyl cellulose, regenerated cellulose, polyvinyl pyrrolidone (PVP), tetrafluoroethylene, polyethylene, polypropylene, an ethylene-propylene-diene polymer (EPDM), a sulfonated-EPDM, styrene-butadiene rubber (SBR), polytetrafluoroethylene (PTFE), fluororubber, various copolymers thereof or the like. These may be used either alone as one type or as a mixture of two or more types, however, this is just one example, and binders known in the art may be used without limit.

The polymer binder is not particularly limited in the content range, but may be specifically included in an amount of 1% by weight to 50% by weight, more preferably 2% by weight to 20% by weight, and even more preferably 3% by weight to 15% by weight with respect to the total weight of the positive electrode slurry. However, this is just a non-limiting example, and the content is not limited to the above-mentioned numerical range.

The conductor according to another embodiment of the present disclosure is used to provide conductivity to the electrodes, and those having electronic conductivity without causing chemical changes may be used without particular limit. Specific examples thereof may include graphite; carbon-based materials such as carbon black, acetylene black, ketjen black, channel black, furnace black, lamp black, thermal black, carbon fiber, carbon nanotube, carbon nanowire and graphene; metal powders or metal fibers of copper, nickel, aluminum, silver and the like; conductive whiskers such as zinc oxide and potassium titanate; conductive metal oxides such as titanium oxide; or conductive polymers such as polyphenylene derivatives, and the like. These may be used either alone as one type or as a mixture of two or more types, however, this is just one example, and any conductor known in the art may be used without limit.

The conductor is not particularly limited in the content range, but may be specifically included in an amount of 0% by weight to 50% by weight, more preferably 1% by weight to 30% by weight, and even more preferably 3% by weight to 20% by weight with respect to the total weight of the positive electrode slurry. However, this is just a non-limiting example, and the content is not limited to the above-mentioned numerical range.

In addition, the positive electrode slurry may further include a solvent for mixing and dispersing the polymer binder, the positive electrode active material and the conductor. Examples of the solvent may include any one selected from among amine-based solvents such as N,N-dimethylaminopropylamine, diethylenetriamine and N,N-dimethylformamide (DMF); ether-based solvents such as tetrahydrofuran; ketone-based solvents such as methyl ethyl ketone; ester-based solvents such as methyl acetate; amide-based solvents such as dimethylacetamide and 1-methyl-2-pyrrolidone (NMP); dimethyl sulfoxide (DMSO) and the like, or a mixed solvent of two or more thereof, however, the solvent is not limited thereto.

The positive electrode slurry according to another embodiment of the present disclosure may have a coating thickness of 10 m to 300 m, more preferably 10 m to 100 m, and even more preferably 10 m to 50 m, however, the thickness is not limited thereto. When the positive electrode slurry is coated to the coating thickness as above, resistance decreases when transferring lithium ions, which may further improve battery performance.

Meanwhile, the current collector according to another embodiment of the present disclosure may be used without particular limit as long as it is a material having electrical conductivity and capable of applying an electric current to the positive electrode material. For example, any one or more selected from the group consisting of C, Ti, Cr, Mo, Ru, Rh, Ta, W, Os, Ir, Pt, Au and Al may be used. Specifically, C, Al, stainless steel or the like may be used as the current collector, and more specifically, Al is preferred in terms of cost and efficiency. A current collector in which a carbon layer is coated on a surface of the current collector may be used. The shape of the current collector is not particularly limited, however, a thin film substrate, a three-dimensional substrate such as foamed metal, mesh, woven fabric, non-woven fabric or foam, or the like may be used, and this is effective in terms of high rate and charge-discharge properties since the positive electrode slurry sufficiently adheres to the current collector, resulting in an electrode with high capacity density even when the content of the polymer binder is low.

Next, a step of b) preparing an electrode assembly in which the positive electrode, a separator and a negative electrode are sequentially interposed may be performed, and this step may be performed according to a common method.

Then, a step of c) inserting the electrode assembly into a battery case, and injecting a flame retardant or non-flammable liquid electrolyte including a lithium salt, the first solvent including the compound represented by Chemical Formula 1 and the second solvent including the compound represented by Chemical Formula 2 to manufacture a lithium secondary battery may be performed.

Herein, the flame retardant or non-flammable liquid electrolyte is the same as described above, therefore, repeated description will not be provided, and the method of injecting the liquid electrolyte may be performed according to a common method.

Hereinafter, the lithium secondary battery and the method for manufacturing the same according to the present disclosure will be described in more detail with reference to examples. However, the following examples are just one reference to describe the present disclosure in detail, and the present disclosure is not limited thereto and may be embodied in various forms.

In addition, unless defined otherwise, all technical terms and scientific terms have the same meanings as meanings generally understood by one of those skilled in the art. Terms used in the description herein are only for effectively describing specific examples, and are not intended to limit the present disclosure. In addition, units of additives not particularly described in the specification may be % by weight.

### PREPARATION EXAMPLE

Preparation of Flame Retardant or Non-Flammable Liquid electrolyte

### Example 1

2,2,2-trifluoroethyl acetate (TFEA) and propylene carbonate (PC) were mixed in a volume ratio of 7:3 to prepare a mixed organic solvent.

To the mixed organic solvent, LiPF₆ was added to a concentration of 1.0 M, and a 1.0 M LiPF₆/TFEA:PC liquid electrolyte was prepared.

### Example 2

All procedures were performed in the same manner as in Example 1 except that 2,2,2-trifluoroethyl propionate (TFEP) was used instead of TFEA.

### Example 3

All procedures were performed in the same manner as in Example 1 except that 2,2,2-trifluoroethyl butyrate (TFEB) was used instead of TFEA.

### Example 4

All procedures were performed in the same manner as in Example 1 except that TFEA and PC were mixed in a volume ratio of 7:3, and a fluoroethylene carbonate (FEC) additive was added in an amount of 2% by weight with respect to the total weight of the liquid electrolyte.

### Example 5

All procedures were performed in the same manner as in Example 1 except that TFEA and PC were mixed in a volume ratio of 7:3, and a vinylene carbonate (VC) additive was added in an amount of 2% by weight with respect to the total weight of the liquid electrolyte.

### Example 6

All procedures were performed in the same manner as in Example 1 except that TFEA and ethylene carbonate (EC) were mixed in a volume ratio of 7:3.

### Example 7

All procedures were performed in the same manner as in Example 1 except that TFEA and PC were mixed in a volume ratio of 9:1.

### Example 8

All procedures were performed in the same manner as in Example 1 except that TFEA and PC were mixed in a volume ratio of 8:2.

### Example 9

All procedures were performed in the same manner as in Example 1 except that TFEA and PC were mixed in a volume ratio of 6:4.

### Example 10

All procedures were performed in the same manner as in Example 1 except that TFEA and fluoroethyl carbonate (FEC) were mixed in a volume ratio of 7:3.

### Comparative Example 1

Ethylene carbonate (EC) and ethyl methyl carbonate (EMC) were mixed in a volume ratio of 3:7 to prepare a mixed organic solvent, and an electrolyte was added in the same manner as in Example 1 to prepare a 1.0 M LiPF₆/EC:EMC liquid electrolyte, an existing commercially available liquid electrolyte.

### Comparative Example 2

All procedures were performed in the same manner as in Comparative Example 1 except that EC and EMC were mixed in a volume ratio of 3:7, and an FEC additive was added in an amount of 2% by weight.

### Comparative Example 3

All procedures were performed in the same manner as in Example 4 except that 2,2,2-trifluoroethyl methyl carbonate (FEMC) was used instead of TFEA.

### Comparative Example 4

All procedures were performed in the same manner as in Example 4 except that di-2,2,2-trifluoroethyl carbonate (DFDEC) was used instead of TFEA.

Specific components for Examples and Comparative Examples are shown in the following Table 1.

TABLE 1

| | First Solvent | Second Solvent | | |
|---|---|---|---|---|
| | (Linear Ester) | (Cyclic Carbonate) | Volume Ratio | Additive (No/Yes) |
| Example 1 | TFEA | PC | 7:3 | No |
| Example 2 | TFEP | (Same as above) | (Same as above) | No |
| Example 3 | TFEB | (Same as above) | (Same as above) | No |
| Example 4 | TFEA | (Same as above) | (Same as above) | Yes (2 wt % FEC) |
| Example 5 | (Same as above) | (Same as above) | (Same as above) | Yes (2 wt % VC)) |
| Example 6 | (Same as above) | EC | (Same as above) | No |
| Example 7 | (Same as above) | PC | 9:1 | No |
| Example 8 | (Same as above) | (Same as above) | 8:2 | No |
| Example 9 | (Same as above) | (Same as above) | 6:4 | No |
| Example 10 | (Same as above) | FEC | 7:3 | No |
| Comparative | EMC | EC | 7:3 | No |
| Example 1 | | | | |
| Comparative | (Same as above) | (Same as above) | (Same as above) | Yes (2 wt % FEC) |
| Example 2 | | | | |
| Comparative | FEMC | PC | (Same as above) | Yes (2 wt % FEC) |
| Example 3 | | | | |
| Comparative | DFDEC | (Same as above) | (Same as above) | Yes (2 wt % FEC) |
| Example 4 | | | | |

### Experimental Example

1) Self-Extinguishing Time (SET, Second/g)

Each of the liquid electrolytes prepared in Examples 1 to 9 and Comparative Examples 1 and 2 was ignited with a torch, and after removing the torch, a self-extinguishing time ((second, s), SET) per the liquid electrolyte weight (g) was measured. SET<6 may be defined as non-flammable, 6<SET<20 as flame retardant and SET≥20 as flammable.

2) Charge-Discharge Test 1

A 2016 coin lithium metal battery (half-cell) formed with a lithium metal negative electrode, a LiNi_{0.6}Co_{0.2}Mn_{0.2}O₂ positive electrode, each of the liquid electrolytes prepared in Examples 1 to 9 and Comparative Examples 1 and 2, and a separator was manufactured.

A charge-discharge cycle of the lithium metal battery was performed 100 times with 1 C (charging for 1 hour) in a voltage range of 2.5 V to 4.6 V to measure discharge capacity per weight (specific gravimetric capacity) and initial Coulombic efficiency under a 0.1 C chemical condition, and a capacity retention rate was calculated according to the following calculation formula.

Capacity retention rate (%)=(discharge capacity after 100 times/discharge capacity after 1 time)×100

3) Internal Interfacial Resistance 1

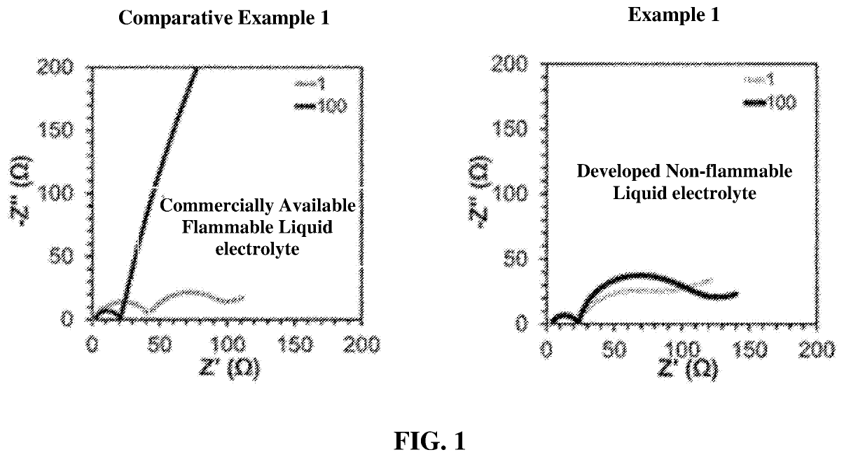

Internal interfacial resistance of the lithium metal battery after performing 1 charge-discharge cycle and 100 charge-discharge cycles was measured using electrochemical impedance spectroscopy (EIS), and the results were graphed using a Nyquist plot and shown in FIG. 1.

Specific test results are shown in the following Table 2.

TABLE 2

| | Evaluation of Liquid | | Li//LiNi_{0.6}Co_{0.2}Mn_{0.2}O₂ Lithium Metal | | |
|---|---|---|---|---|---|
| | electrolyte Properties | | Battery Charge-Discharge Test 1 | | |
| | | Determination | Discharge | Capacity | Initial |
| | SET | of Non- | Capacity | Retention Rate | Coulombic |
| | (second/g) | Flammability | (1 C) (mAh/g) | (1 C) (%) | Efficiency (%) |
| Example 1 | 2.5 | Non- | 189 | 77 | 89 |
| | | Flammable | | | |
| Example 2 | 7.8 | Flame | 191 | 85 | 87 |
| | | Retardant | | | |
| Example 3 | 10.8 | Flame | 187 | 76 | 81 |
| | | Retardant | | | |
| Example 4 | 0 | Non- | — | — | — |
| | | Flammable | | | |
| Example 5 | 0 | Non- | — | — | — |
| | | Flammable | | | |
| Example 6 | 2.3 | Non- | 187 | 65 | 88 |
| | | Flammable | | | |
| Example 7 | 0 | Non- | 177 | 17 | 69 |
| | | Flammable | | | |
| Example 8 | 0 | Non- | 188 | 42 | 89 |
| | | Flammable | | | |
| Example 9 | 4 | Non- | 185 | 69 | 76 |
| | | Flammable | | | |
| Example 10 | 0 | Non- | — | — | — |
| | | Flammable | | | |
| Comparative | 60 | Flammable | 180 | 75 | 91 |
| Example 1 | | | | | |
| Comparative | 47 | Flammable | — | — | — |
| Example 2 | | | | | |
| Comparative | 0 | Non- | — | — | — |
| Example 3 | | Flammable | | | |
| Comparative | 0 | Non- | — | — | — |
| Example 4 | | Flammable | | | |

As described in Table 2, the liquid electrolytes of Comparative Examples 1 and 2, which are existing commercially available liquid electrolytes, had a self-extinguishing time measured as 60 seconds/g and 47 seconds/g, respectively, and showed flammable properties. The liquid electrolytes of Comparative Examples 3 and 4 all had a self-extinguishing time measured as 0 second/g and showed non-flammable properties.

On the other hand, the liquid electrolytes of Examples 1 to 9 had, despite including 10% by volume to 40% by volume of PC known as a flammable material, a self-extinguishing time measured as less than 20 seconds/g, and were identified to have non-flammable and flame retardant properties.

Particularly, Examples 1 and 2 were measured to have 1 C discharge capacity of 189 mAh/g or greater, a 1 C capacity retention rate of 77% or greater and initial Coulombic efficiency of 87% or greater in the Li//LiNi_{0.6}Co_{0.2}Mn_{0.2}O₂ lithium metal battery (half-cell), and exhibited excellent battery properties despite having non-flammable properties. As shown in FIG. 1, the half-cell of Example 1 was effective in suppressing an increase in the interfacial resistance during the 100 charge-discharge cycles compared to the cell of Comparative Example 1.

However, Examples 7 to 9 with different mixing ratios of the first solvent and the second solvent had degraded battery properties compared to Examples 1 and 2, although having non-flammable properties.

4) Charge-Discharge Test 2

A 2032 coin lithium ion battery (full-cell) formed with a graphite negative electrode, a LiNi_{0.6}Co_{0.2}Mn_{0.2}O₂ positive electrode, each of the liquid electrolytes prepared in Examples 4 and 5 and Comparative Example 2, and a separator was manufactured.

A charge-discharge cycle of the lithium battery including the liquid electrolyte was performed 100 times with 1 C (charging for 1 hour) in a voltage range of 2.5 V to 4.5 V to measure specific gravimetric capacity, and initial Coulombic efficiency under a 0.1 C chemical condition.

5) Charge-Discharge Test 3

A 2032 coin lithium ion battery (full-cell) formed with a graphite negative electrode, a LiNi_{0.82}Co_{0.11}Mn_{0.0702}O₂ positive electrode, each of the liquid electrolytes prepared in Examples 4 and 5 and Comparative Examples 2 to 4, and a separator was manufactured.

A charge-discharge cycle of the lithium battery including the liquid electrolyte was performed 100 times with 3 C (charging for 20 minutes) in a voltage range of 2.7 V to 4.3 V to measure specific gravimetric capacity, and initial Coulombic efficiency under a 0.1 C chemical condition.

The test results are shown in the following Table 3.

TABLE 3

| | Graphite//LiNi_{0.6}Co_{0.2}Mn_{0.2}O₂ | | | Graphite//LiNi_{0.82}Co_{0.11}Mn_{0.0702}O₂ | | |
|---|---|---|---|---|---|---|
| | Lithium Ion Battery | | | Lithium Ion Battery | | |
| | | Capacity | Initial | | Capacity | Initial |
| | Discharge | Retention | Coulombic | Discharge | Retention | Coulombic |
| | Capacity | Rate | Efficiency | Capacity | Rate | Efficiency |
| | (1 C) (mAh/g) | (1 C) (%) | (%) | (3 C) (mAh/g) | (3 C) (%) | (%) |
| Example 4 | 192 | 89 | 88 | 192 | 86 | 83 |
| Example 5 | 184 | 80 | 87 | — | — | — |
| Comparative | 181 | 44 | 84 | — | — | — |
| Example 1 | | | | | | |
| Comparative | 196 | 68 | 86 | 195 | 27 | 78 |
| Example 2 | | | | | | |
| Comparative | — | — | — | 165 | 75 | 81 |
| Example 3 | | | | | | |
| Comparative | — | — | — | 156 | 6 | 64 |
| Example 4 | | | | | | |

As described in Table 3, the liquid electrolytes of Examples 4 and 5 had improved battery properties in capacity or capacity retention rate, and Coulombic efficiency under conditions of 1 C and 3 C in the graphite//LiNi_{0.6}Co_{0.2}Mn_{0.2}O₂ and graphite//LiNi_{0.82}Co_{0.11}Mn_{0.0702}O₂ lithium ion batteries (full-cell) compared to the liquid electrolytes of Comparative Examples 1 to 4, which are existing commercially available liquid electrolytes. Particularly, Example 4 described in Table 3 had significantly improved battery properties under a condition of 3 C (charging for 20 minutes), and battery properties such as capacity or capacity retention rate, and Coulombic efficiency were improved compared to Comparative Examples 3 and 4 as well as Comparative Example 2, which are existing commercially available liquid electrolytes. This indicates that, by using the liquid electrolyte of the present disclosure, the battery may be rapidly charged and a lifetime of the battery is improved even under the condition of high charging rate.

6) Charge-Discharge Test 4

A 2032 coin lithium ion battery (full-cell) formed with a high-loading graphite negative electrode, a LiNi_{0.6}Co_{0.2}Mn_{0.2}O₂ positive electrode (active material per area: 17.6 mg/cm²), each of the liquid electrolytes prepared in Example 4 and Comparative Example 2, and a separator was manufactured.

A charge-discharge cycle of the lithium ion battery including the liquid electrolyte was performed 500 times with 2 C (charging for 30 minutes) in a high charging voltage range of 2.5 V to 4.5 V to measure discharge capacity per weight (specific gravimetric capacity) and initial Coulombic efficiency under a 0.1 C chemical condition, and a capacity retention rate was calculated according to the following calculation formula.

Capacity retention rate (%)=(discharge capacity after 500 times/discharge capacity after 1 time)×100

7) Internal Interfacial Resistance 2

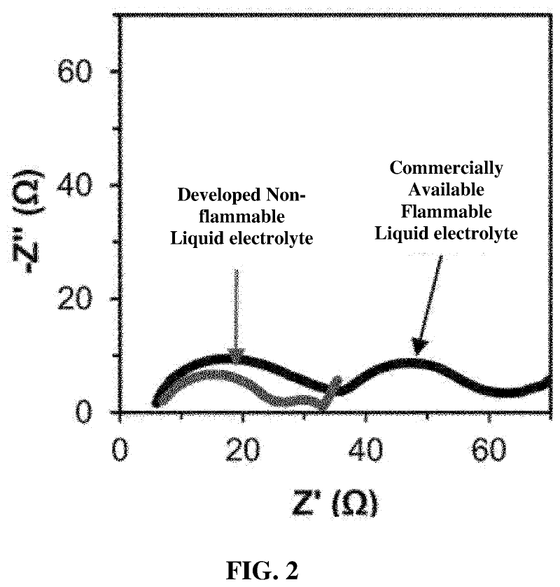

Internal interfacial resistance of the lithium ion battery after performing 500 charge-discharge cycles was measured using EIS, and the results were graphed using a Nyquist plot and shown in FIG. 2.

The test results are shown in FIG. 2 and the following Table 4.

TABLE 4

| | Graphite//LiNi_{0.6}Co_{0.2}Mn_{0.2}O₂ Lithium Ion Battery | | |
|---|---|---|---|
| | Discharge | Capacity | Initial |
| | Capacity | Retention Rate | Coulombic |
| | (2 C) (mAh/g) | (2 C) (%) | Efficiency (%) |
| Example 4 | 142 | 52 | 77 |
| Comparative | 130 | 6 | 88 |
| Example 2 | | | |

As described in Table 4, the liquid electrolyte of Example 4 had improved battery properties in capacity and capacity retention rate under a condition of 2 C (charging for 30 minutes) in the high-loading graphite//LiNi_{0.6}Co_{0.2}Mn_{0.2}O₂ lithium ion battery (full-cell) compared to the liquid electrolyte of Comparative Example 2, an existing commercially available liquid electrolyte. This indicates that, by using the liquid electrolyte of the present disclosure, the charging rate may be improved in a battery manufactured with a high-loading active material at a commercialization level as well, and a lifetime of the battery is improved under a rapid charge condition. In addition, as shown in FIG. 2, the full-cell of Example 4 was effective in suppressing an increase in the interfacial resistance compared to the existing commercially available liquid electrolyte during the 500 charge-discharge cycles under the condition of 2 C compared to the cell of Comparative Example 2.

8) Charge-Discharge Test 5

A 2032 coin lithium ion battery (full-cell) formed with a high-loading silicon oxide (SiO) (5% by weight)-graphite composite negative electrode, a LiNi_{0.88}Co_{0.08}Mn_{0.04}O₂ positive electrode (active material per area: 18 mg/cm²), each of the liquid electrolytes prepared in Example 10 and Comparative Example 2, and a separator was manufactured.

A charge-discharge cycle of the lithium ion battery including the liquid electrolyte was performed 100 times with 1 C (charging for 1 hour) in a high voltage range of 2.5 V to 4.35 V to measure specific gravimetric capacity and initial Coulombic efficiency under a 0.1 C chemical condition, and a capacity retention rate was calculated according to the following calculation formula.

Capacity retention rate (%)=(discharge capacity after 400 times/discharge capacity after 1 time)×100

TABLE 5

| | SiO-Graphite//LiNi_{0.88}Co_{0.08}Mn_{0.04}O₂ Lithium Ion Battery | | |
|---|---|---|---|
| | Discharge | Capacity | Initial |
| | Capacity | Retention Rate | Coulombic |
| | (1 C) (mAh/g) | (1 C) (%) | Efficiency (%) |
| Example 10 | 192 | 88 | 86 |
| Comparative | 188 | 72 | 82 |
| Example 2 | | | |

As described in Table 5, the liquid electrolyte of Example 10 had improved battery properties in capacity, capacity retention rate and initial Coulombic efficiency under a condition of 1 C (charging for 1 hour) in the high-loading SiO-graphite composite//LiNi_{0.88}Co_{0.08}Mn_{0.04}O₂ lithium ion battery (full-cell) compared to the liquid electrolyte of Comparative Example 2, an existing commercially available liquid electrolyte. This indicates that, by using the liquid electrolyte of the present disclosure, properties and lifetime of the high energy density battery in which a high-capacity silicon oxide-graphite composite negative electrode active material is used in high loading at a commercialization level are improved.

9) Charge-Discharge Test 6

A 730 mAh pouch lithium ion battery formed with a graphite negative electrode, a LiNi_{0.8}Co_{0.1}Mn_{0.1}O₂ positive electrode, each of the liquid electrolytes prepared in Example 4 and Comparative Example 2, and a separator was manufactured.

A charge-discharge cycle of the pouch lithium ion battery including the liquid electrolyte was performed 400 times with 1 C (charging for 1 hour) in a high voltage range of 2.7 V to 4.3 V to measure discharge capacity and initial Coulombic efficiency under a 0.1 C chemical condition, and a capacity retention rate was calculated according to the following calculation formula.

Capacity retention rate (%)=(discharge capacity after 400 times/discharge capacity after 1 time)×100

10) Internal Resistance of Pouch Battery

Internal resistance of the pouch lithium ion battery after performing 1 charge-discharge cycle and 400 charge-discharge cycles was measured using direct current-internal resistance (DC-IR), an electrochemical method.

Test results are shown in the following Table 6.

TABLE 6

| | Graphite//LiNi_{0.8}Co_{0.1}Mn_{0.1}O₂ Pouch Lithium Ion Battery | | | | |
|---|---|---|---|---|---|
| | Discharge | Capacity | Initial | DC-IR Internal | |
| | Capacity | Retention | Coulombic | Resistance (Ω) | |
| | (1 C) | Rate (1 C) | Efficiency | After 1 | After 400 |
| | (mAh) | (%) | (%) | Cycle | Cycles |
| Example 4 | 732 | 82 | 86 | 0.32 | 0.38 |
| Comparative | 633 | 56 | 80 | 0.21 | 0.60 |
| Example 2 | | | | | |

As described in Table 6, the liquid electrolyte of Example 4 had improved battery properties in all of initial discharge capacity, capacity retention rate and initial Coulombic efficiency in the graphite//LiNi_{0.8}Co_{0.1}Mn_{0.1}O₂ 730 mAh pouch lithium ion battery compared to the liquid electrolyte of Comparative Example 2, an existing commercially available liquid electrolyte. From this, it was identified that, by using the liquid electrolyte of the present disclosure, capacity of the pouch battery at a commercialization level increased, and the capacity retention rate and the lifetime were improved as well. In addition, it was identified that internal resistance of the battery measured through DC-IR increased by approximately 3 times when using the liquid electrolyte of Comparative Example 2, whereas the effect of suppressing changes in the resistance of the pouch battery was obtained when using the liquid electrolyte of Example 4.

Hereinbefore, preferred embodiments of the present disclosure have been described in detail, however, the scope of a right of the present disclosure is not limited thereto, and various modified and improved forms made by those skilled in the art using the basic concept of the present disclosure defined in the claims also fall within the scope of a right of the present disclosure.

### INDUSTRIAL APPLICABILITY

The present disclosure relates to a flame retardant or non-flammable liquid electrolyte and a lithium secondary battery including the same.

1. A flame retardant or non-flammable liquid electrolyte comprising:
a lithium salt;
a first solvent including a compound represented by the following Chemical Formula 1; and
a second solvent including a compound represented by the following Chemical Formula 2: 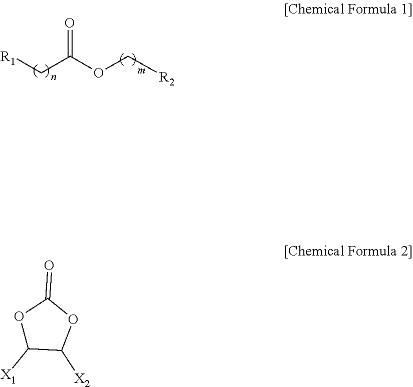
wherein,
n and m are the same as or different from each other, and each independently an integer of 0 to 5;
R₁ and R₂ are the same as or different from each other, and each independently hydrogen or a substituted or unsubstituted alkyl group having 1 to 10 carbon atoms; and
X₁ and X₂ are the same as or different from each other, and each independently selected from the group consisting of hydrogen, a halogen group and a substituted or unsubstituted alkyl group having 1 to 10 carbon atoms.

2. The liquid electrolyte of claim 1, wherein the lithium salt is selected from the group consisting of LiPF₆, LiClO₄, LiAsF₆, LiBF₄, LiSbF₆, LiAlO₄, LiAlCl₄, LiCF₃SO₃, LiC₄F₉SO₃, LiC₆H₅SO₃, LiN(C₂F₅SO₃)₂, LiN(C₂F₅SO₂)₂, LiN(CF₃SO₂)₂, LiN(FSO₂)₂, LiN(CₓF₂ₓ₊₁SO₂)(C_{y}F_{2y+1}SO₂) (herein, x and y are 0 or natural number), LiCl, LiI, LiSCN, LiB(C₂O₄)₂, LiF₂BC₂O₄, LiPF₄(C₂O₄), LiPF₂(C₂O₄)₂, LiPO₂F₂, LiP(C₂O₄)₃ and mixtures thereof.

3. The liquid electrolyte of claim 1, wherein the first solvent and the second solvent have a volume ratio of 99:1 to 1:99.

4. The liquid electrolyte of claim 1, wherein the first solvent and the second solvent have a volume ratio of 90:10 to 10:90.

5. The liquid electrolyte of claim 1, which has a self-extinguishing time (SET) of less than 20 seconds/g.

6. A lithium secondary battery comprising:
a positive electrode including a positive electrode active material;
the flame retardant or non-flammable liquid electrolyte of claim 1;
a negative electrode; and
a separator.
